(19) United States
(12) Patent Application Publication
(10) Pub. No.: US 2003/0022681 A1
(43) Pub. Date: Jan. 30, 2003

(54) Adaptive dynamic technique for multi-path signal processing

(76) Inventors: Christopher D. Ruppel, Kokomo, IN (US); Rohail A. Pervez, Kokomo, IN (US); Daniel T. Altizer, Kokomo, IN (US)

Correspondence Address: STEFAN V. CHMIELEWSKI, DELPHI TECHNOLOGIES,INC., Legal Staff Mail Code A-107, P. O. Box 9005, Kokomo, IN, 46904-9005, US

(21) Appl. No.: 09/911,087

(22) Filed: Jul. 24, 2001

(51) Int. Cl. H04B 7/005

(52) U.S. Cl. 455/506; 455/504; 455/296

(57) ABSTRACT

A mobile receiver, located within a vehicle, exhibits improved signal processing in the presence of multi-path distortion. Initially, the speed of the vehicle is determined. Next, signal information on a selected signal received by the mobile receiver is collected. The collected signal information provides an indication of the quality of the received signal. Then, at least one time constant associated with the processing of the collected signal information is modified responsive to the determined speed.

### TECHNICAL FIELD

The present invention is directed to a receiver and, more specifically, a receiver with improved signal processing in the presence of multi-path distortion.

### BACKGROUND OF THE INVENTION

In an automotive frequency modulation (FM) receiver that does not incorporate dynamic signal processing, an FM tuner receives a signal and provides an unprocessed composite audio to stereo decoding and de-emphasis circuits. In an automotive FM receiver that performs dynamic signal processing, an FM tuner provides an unprocessed composite audio signal, as well as signal quality and noise flags. The noise flags may provide an indication of a signal level, a wideband amplitude modulation (WBAM) level and/or an ultrasonic noise (USN) level, which provide an indication of a multi-path distortion level.

FM receivers that perform dynamic signal processing have generally implemented fixed time constants and a matrix of gains, which are provided for stereo decoding and audio processing functions, such as stereo noise control (SNC), high-cut, soft-mute, etc. The performance of the audio processing functions are then determined by the matrix of gains and fixed time constants, which operate on the noise flags.

Unfortunately, commercially available FM receivers that perform dynamic signal processing are somewhat inflexible when utilized in mobile applications, since they utilize fixed dynamic time constants. This can be problematic in that a typical FM receiver processes antenna signals, which may be, periodically, corrupted by multi-path distortion. Multi-path distortion may occur when a selected channel signal has propagated from a broadcast antenna to a receiver antenna (or antennas) by several paths, including reflections, which may be unequal in path length and gain. Multipath distortion results when unequal signal path propagation modes are summed.

Multi-path distortion of a signal channel generally varies both by antenna location and by instantaneous channel frequency. The multi-path variation by location produces signal amplitude peak and null points, which are separated by distances on the same order of magnitude as the channel frequency. For example, an FM signal at one-hundred megahertz has a wavelength of approximately three meters. The multi-path variation by instantaneous frequency can also produce selective cancellation of acceptable frequencies within the channel bandwidth.

An example of an existing adaptive reception technique is the stereo noise control (SNC) feature, included in many automotive FM stereo receivers. Since an FM composite stereo signal utilizes more bandwidth than its FM mono portion, full FM stereo is generally more susceptible to audible multi-path distortion effects than the FM mono portion. An FM receiver that includes dynamic SNC processing continuously varies (i.e., blends) the audio mode between full stereo and mono in order to reduce audible multi-path distortion effects, while still preserving stereo mode to maximize audio fidelity, whenever possible. Dynamic high-cut and dynamic soft-mute are other processing techniques, which also minimize audible noise by reducing audio bandwidth and amplitude, respectively, at appropriate instances.

As previously mentioned, existing FM stereo receivers that implement SNC, high-cut and soft-mute processing offer audio processing dynamic transitions that occur based on several fixed time (i.e., attack time and decay time) constants, as defined by components of the receiver. For example, SNC processing causes a receiver to transition from a stereo to mono based on significant amounts of channel degradation and then recover to full stereo mode as long as the channel is measured to be relatively strong and distortion free for a set time. Likewise, separate fixed processing dynamics (i.e., fixed time constants) are used to initiate the high-cut and soft-mute functions. These fixed time constants are also selected during the design of the receiver and also provide compromised performance under many possible reception environments (e.g., urban, rural, slow speed, high speed, etc.). However, when an FM receiver is located in a moving vehicle, multi-path distortion varies with the position of the vehicle and, thus, performance of the receiver with fixed time constants is further degraded.

Thus, what is needed is an FM receiver that optimizes processing dynamics, based upon the speed of the vehicle in which the FM receiver is located.

### SUMMARY OF THE INVENTION

The present invention is directed to a system and method for improving the signal processing capability of a mobile receiver, located in a vehicle, in the presence of multi-path distortion. Initially, the speed of the vehicle is determined. Next, signal information on a selected signal received by the mobile receiver is collected. The collected signal information provides an indication of the quality of the received signal. Then, at least one time constant associated with the collected signal information is modified responsive to the determined speed.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an electrical block diagram of a relevant portion of an exemplary FM receiver;

FIG. 2A is a block diagram of a relevant portion of an exemplary signal quality circuit;

FIG. 3 is a block diagram of a relevant portion of an exemplary signal quality circuit, according to an embodiment of the present invention; and

FIG. 4 is a block diagram of various exemplary automotive subsystems implemented within a motor vehicle.

### DESCRIPTION OF THE PREFERRED EMBODIMENT(S)

According to the present invention, an adaptive dynamic technique is implemented that uses vehicle speed and/or position as an input variable to a signal processing circuit of an FM receiver. The vehicle speed can be obtained from vehicle sensors over a wire or bus (from, for example, an automotive transmission subsystem module). Alternatively, vehicle speed can be ascertained through location information provided by an onboard global positioning system (GPS) receiver. A processor of the FM receiver utilizes the speed and/or location inputs to adjust dynamic time constants associated with processing of a received signal. For example, since a vehicle moving at a high speed will not remain within multi-path nulls for an appreciable amount of time, the signal processing circuit implements short dynamic time constants when the vehicle is traveling at a high speed. On the other hand, the signal processing circuits use longer dynamic time constants when processing a received signal when the vehicle is travelling at a slower speed or is stopped in traffic, as the vehicle will remain in multi-path nulls for a longer period of time. While the discussion herein is directed to FM receivers located in an automobile, it is contemplated that other types of receivers located in other mobile vehicles (e.g., boats) may benefit from the adaptive dynamic technique, disclosed herein.

According to the present invention, an adaptive dynamic technique allows an FM receiver to minimize multi-path distortion, while maximizing reception fidelity, without the compromise of using fixed time constants in existing FM receivers. The adaptive dynamic technique can be implemented within hardware or within software, i.e., by executing an appropriate algorithm within a digital signal processor (DSP) of an FM receiver. While existing DSP solutions offer a fixed matrix of gains and fixed time constants between station quality, noise flags and final signal processing operations, the adaptive dynamic technique, according to the present invention, utilizes vehicle speed/location information to alter the processing time constants. For example, the stereo noise control (SNC) dynamic time constant may be adaptively adjusted between values less than one second to greater than twenty seconds, based on the vehicle speed.

According to the present invention, which implements adaptive dynamic signal processing within an FM receiver, an FM tuner provides unprocessed composite audio and signal quality/noise flags based on a signal level, a WBAM level and a USN level associated with a received signal. However, unlike prior art FM receivers, the present invention uses vehicle inputs, such as speed and/or GPS location information, which is utilized to determine the speed of the vehicle. The vehicle inputs are utilized to change the time constants associated with a signal quality circuit (e.g., a weak signal processing circuit). As previously mentioned, lower speeds preferably cause longer dynamic time constants to be implemented, whereas higher speeds preferably cause shorter dynamic time constants to be utilized. In this manner, the control of the audio processing functions are determined by a flexible matrix of gains and variable time constants operating on the noise flags. Thus, functions such as SNC, high-cut and soft-mute can be optimized, while the vehicle transitions through a number of road conditions.

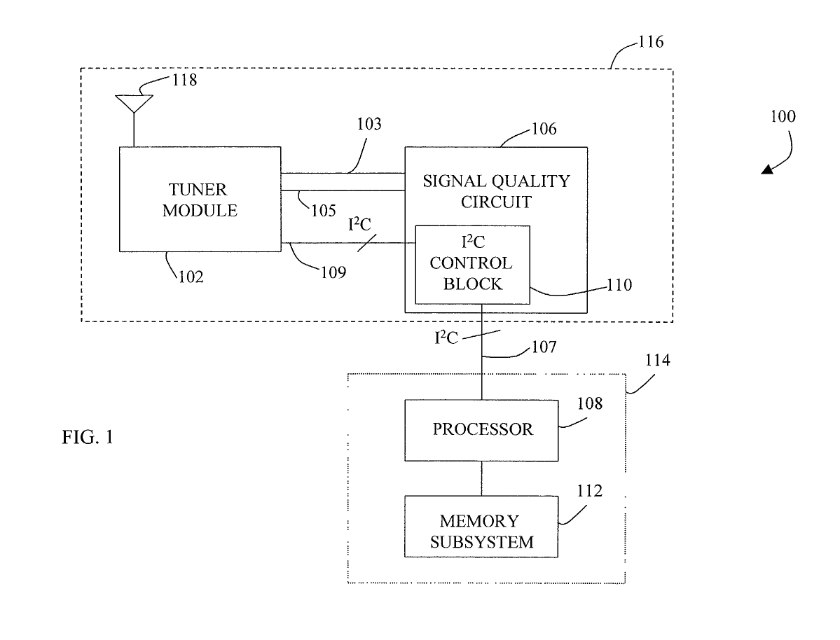

Turning to FIG. 1, a block diagram of an exemplary FM receiver 100 is depicted. The FM receiver 100 includes a processor 108, which can be a digital signal processor (DSP), that is coupled to a memory subsystem 112, which includes an application appropriate amount of volatile and non-volatile memory. It will be appreciated that the processor 108 and the memory subsystem 112 can be incorporated within a controller 114. As shown, the processor 108 is coupled to an inter-integrated circuit (I²C) control block 110 located within a signal quality circuit 106, via an I²C bus 107. It should be appreciated that the processor 108 can communicate with the circuit 106 via other serial or parallel buses. The processor 108 communicates (reads/writes) with various registers located within the signal quality circuit 106 (e.g., a TEA6880H manufactured and made commercially available by Philips). The signal quality circuit 106 is coupled to a tuner module 102 (e.g., a TEA6840H manufactured and made commercially available by Philips) through a number of signal lines 101, 103, 105 and 109. As shown, the tuner module 102 is coupled to an antenna 118 for receiving radio signals.

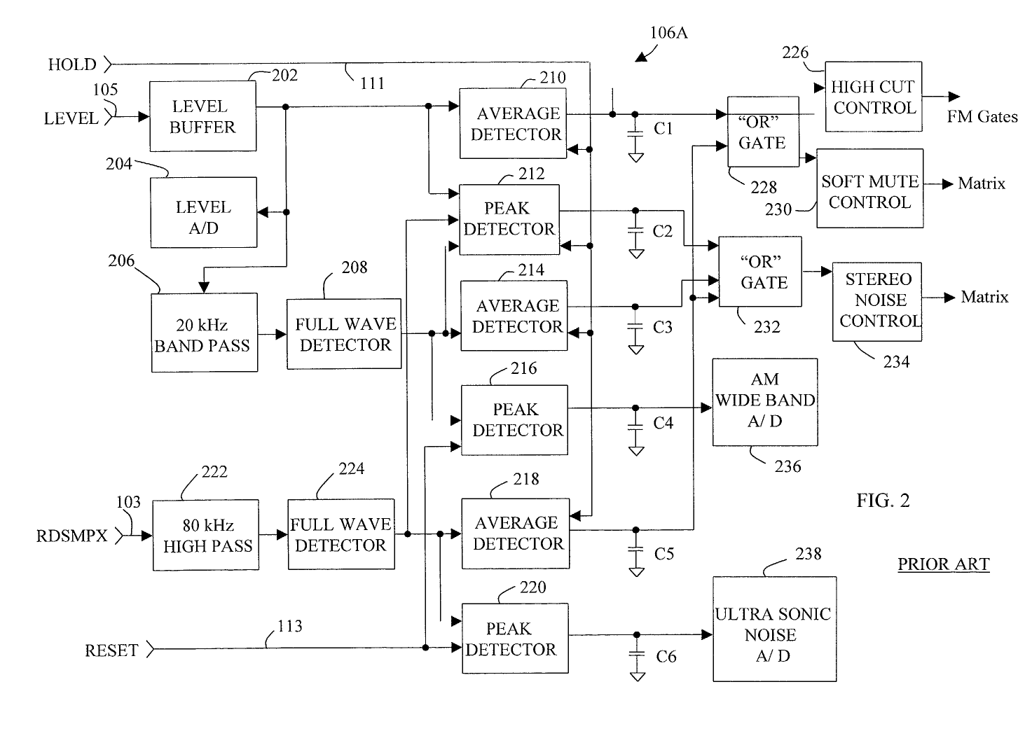

FIG. 2 depicts an electrical block diagram of relevant portions of a signal quality circuit 106A, according to the prior art. As depicted in FIG. 2, the circuit 106A includes a level buffer 202 that receives a level signal from the tuner module 101, which indicates the level of a received signal, on signal line 105. An output of the level buffer 202 provides the level signal to an input of a level analog-to-digital (A/D) converter 204, which provides a digital indication of the magnitude of the level signal, and to an input of a 20 kHz bandpass filter 206. The 20 kHz bandpass filter 206 filters the level signal and provides the signal to a full-wave detector 208. An output of the full-wave detector 208 provides the filtered level signal to an input of an average detector 214, a peak detector 212 and a peak detector 216. The output of the level buffer 202 also provides the level signal to an input of an average detector 210 and a peak detector 212.

A hold signal is provided, from the I²C control block 110, on signal line 111 and is utilized to control operation of the average detector 210, the peak detector 212, the average detector 214 and an average detector 218. A reset signal is provided (from the I²C control block 110) on signal line 113, which is coupled to the peak detector 220 and the peak detector 216. Attack times and decay times for the detectors 210-220 are set by external capacitors as follows: the attack and decay times for the average detector 210 are set by capacitor C1; the attack and decay times for the peak detector 212 are set by capacitor C2; the attack and decay times for the average detector 214 are set by capacitor C3; the attack and decay times for the peak detector 216 are set by capacitor C4; the attack and decay times for the average detector 218 are set by capacitor C5; and capacitor C6 sets the attack and decay time for the peak detector 220. It should be appreciated that the conventional attack and decay times for the detectors 210-220 of FIG. 2 are fixed.

A radio data system multiplex (RDSMPX) signal is provided from the tuner module 102, on signal line 103, to an input of an 80 kHz high-pass filter 222. An output of the filter 222 provides the filtered RDSMPX signal to an input of a full-wave detector 224, whose output is coupled to an input of the peak detector 212, an input of the average detector 218 and an input of the peak detector 220. An output of the average detector 218 is provided to a first input of ‘OR’ gate 232 and a first input of ‘OR’ gate 228. An output of the peak detector 216 is provided to a wideband AM (WBAM) A/D converter, which provides a digital indication of the WBAM level associated with the received signal. An output of the peak detector 220 is provided to an input of an ultrasonic noise (USN) A/D converter 238, which provides a digital indication of the USN level presently associated with the received signal. An output of the average detector 210 is provided to a second input of the ‘OR’ gate 228.

It should be appreciated that the ‘OR’ gate 228 is actually an analog ‘OR’ gate, in which the input representing the “lowest signal quality” (e.g., lowest level signal level or highest USN level) is the dominant input and, as such, is passed on to the soft-mute control block 230, which initiates implementation of the soft-mute function responsive thereto.

An output of the average detector 210 is also coupled to a high-cut control block 226, which implements high-cut control responsive to the output of the average detector 210. The outputs of the peak detector 212, the average detector 214 and the average detector 218 are coupled to inputs of the ‘OR’ gate 232. It should be appreciated that the ‘OR’ gate 232 is also an analog ‘OR’ gate, in which the input representing the “lowest signal quality” (e.g., lowest level signal level, highest WBAM level or highest USN level) is the dominant input and, as such, is passed on to the stereo noise control (SNC) block 234, which responsive to the passed signal implements stereo noise control. The output of the high-cut control block 226 is provided to FM gates, while the outputs of the soft-mute control block 230 and the SNC block 234 are utilized with the fixed gain matrix.

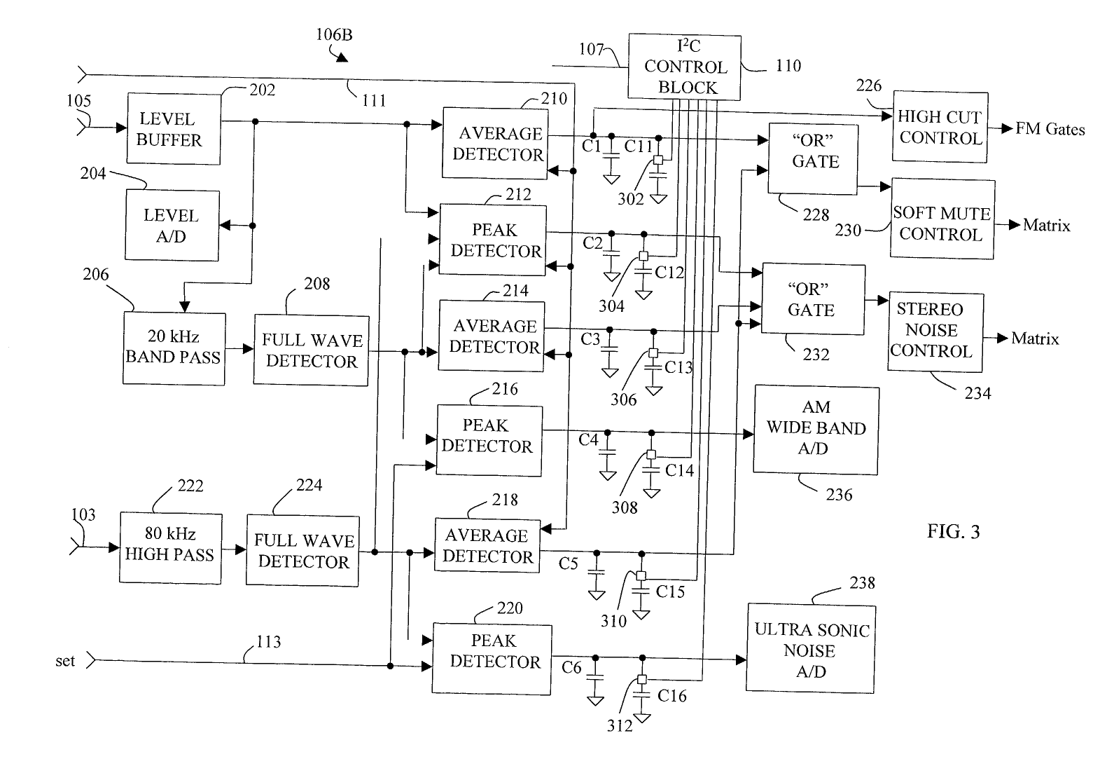

FIG. 3 depicts an exemplary electrical block diagram of a signal quality circuit 106B that allows time constants to be dynamically modified, according to one embodiment of the present invention. Portions of the circuit 106B that show components common with the circuit 106A of FIG. 2, use the same item numbers. The primary difference between the embodiments of FIG. 2 and FIG. 3 is that the I²C control block 110 is coupled to a plurality of switches, e.g., field-effect transistors (FETs), 302-312, which allow the time constants associated with the detectors 210-220 to be dynamically altered. Based upon the vehicle speed, the processor 108 provides an I²C control signal, on the signal line 107, to the I²C control block 110, which causes one or more of the switches 302-312 to close or open. Closing one of the switches 302-312 causes one of the capacitors C11-C16 to be added in parallel with one of the existing capacitors C1-C6, respectively. This in turn causes one or more of the attack and decay time constants, associated with the detectors 210-220, to increase. As discussed above, this is implemented responsive to the speed/position of the vehicle to adjust the time constants responsive to the speed of the vehicle. Alternatively, the capacitors C1-C6 may be removed and the capacitors C11-C16 and switches 302-312 may each be replaced with analog circuitry, whose capacitance can be continuously varied to modify associated attack and decay times. However, due to the complexity of such analog circuitry, it may be more practical to implement a DSP that is programmed to continuously vary the attack and decay times, based on the speed of the vehicle.

As previously mentioned, a DSP can be used to periodically sample a received signal and select an appropriate time constant, based on the speed of the vehicle in which the FM receiver is located, for use in a signal processing algorithm. Alternatively, the DSP may implement a polynomial function to determine an appropriate time constant, based on the vehicle speed. It will be appreciated that implementing a polynomial function to determine an appropriate time constant may be preferred if a look-up table that stores time constants is required to store more than a few values (e.g., eight values).

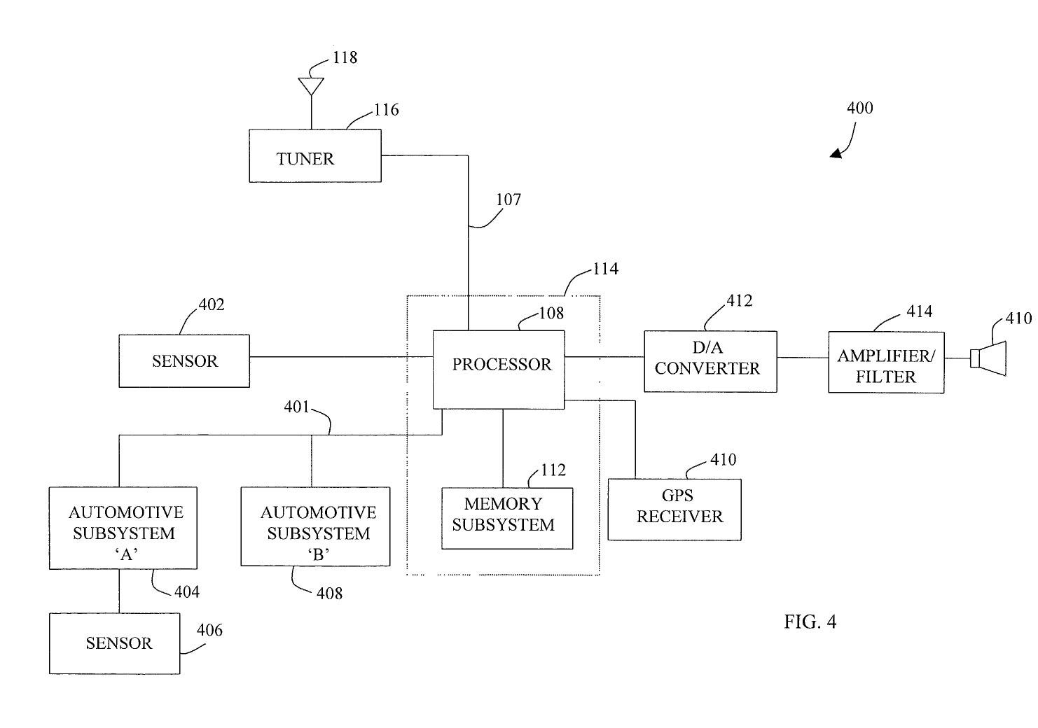

FIG. 4 depicts an automotive system 400 constructed according to an embodiment of the present invention. As shown, the processor 108 is coupled to a sensor 402 that provides an indication of the speed of a motor vehicle in which the system 400 is located. Alternatively, the processor 108 may receive speed information from an automotive subsystem ‘A’ 404, which can be a transmission module that is coupled to a sensor 406. The sensor 406 provides speed information to the subsystem 404, which, in turn, provides the information to the processor 108 on a bus (i.e., a serial bus) 401. The automotive subsystem ‘B’ (e.g., a collision avoidance subsystem) 408 may also communicate with other subsystems (not shown) over the bus 401. As previously discussed, the processor 108 may also receive location information from a GPS receiver 410 and derive the speed from the provided location information. The processor 108 may also provide audio to a driver of the vehicle via a D/A converter 412, amplifier/filter 414 and speaker 410.

Accordingly, an automotive subsystem has been described that includes a mobile receiver that exhibits improved signal processing in the presence of multi-path distortion. As discussed above, the mobile receiver is located within the motor vehicle and includes a tuner module coupled to a signal quality circuit, which is coupled to a processor. The processor is coupled to a memory subsystem and at least one of a vehicle sensor and a ground positioning system (GPS) receiver, which provides an indication of the speed of the vehicle. As discussed above, the processor determines the speed of the vehicle and collects signal information on a selected signal received by the mobile receiver. The collected signal information is provided by the signal quality circuit and provides an indication of the quality of the received signal. In response to the collected signal information, the processor modifies at least one time constant associated with processing of the collected signal information.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. A method for improving signal processing of a mobile receiver located in a vehicle in the presence of multipath distortion, the method comprising the steps of:
determining a speed of the vehicle;
collecting signal information on a selected received signal that is received by the mobile receiver, the collected signal information providing an indication of the quality of the received signal; and
modifying at least one time constant associated with processing of the collected signal information responsive to the determined speed.

2. The method of claim 1, wherein the speed of the vehicle is provided by a vehicle sensor.

3. The method of claim 1, wherein the speed of the vehicle is determined from position locations provided by a ground positioning system (GPS) receiver.

4. The method of claim 1, wherein the collected signal information is provided by a signal quality circuit, and wherein the at least one time constant includes an attack time and a decay time of the signal quality circuit.

5. The method of claim 1, wherein a length of the at least one time constant is inversely proportional to the speed of the vehicle.

6. The method of claim 1, wherein the collected signal information is provided by a signal quality circuit, and wherein the collected signal information provides an indication of an ultrasonic noise (USN) level associated with the received signal.

7. The method of claim 6, wherein the collected signal information also provides an indication of a wideband amplitude modulation (WBAM) level associated with the received signal.

8. The method of claim 1, wherein the collected signal information is provided by a signal quality circuit that includes at least one of an average detector, a peak detector and a full-wave detector.

9. The method of claim 8, wherein at least one output of the at least one of an average detector, a peak detector and a full-wave detector is utilized to initiate at least one of a soft-mute, a high-cut and a stereo noise control function.

10. A mobile receiver that exhibits improved signal processing in the presence of multipath distortion, the mobile receiver being located within a vehicle, the mobile receiver comprising:
a tuner module;
a signal quality circuit coupled to the tuner module;
a memory subsystem for storing information; and
a processor coupled to the memory subsystem and the signal quality circuit, the processor executing code for causing the processor to perform the steps of:
determining a speed of the vehicle;
collecting signal information on a selected signal received by the mobile receiver, wherein the collected signal information is provided by the signal quality circuit and provides an indication of the quality of the received signal; and
modifying at least one time constant associated with processing of the collected signal information responsive to the determined speed.

11. The receiver of claim 10, wherein the processor is coupled to a vehicle sensor that provides the speed of the vehicle.

12. The receiver of claim 10, wherein the processor is coupled to a ground positioning system (GPS) receiver that provides vehicle locations from which the speed of the vehicle is determined.

13. The receiver of claim 10, wherein the at least one time constant includes an attack time and a decay time of the signal quality circuit.

14. The receiver of claim 10, wherein a length of the at least one time constant is inversely proportional to the speed of the vehicle.

15. The receiver of claim 10, wherein the collected signal information provides an indication of an ultrasonic noise (USN) level associated with the received signal.

16. The receiver of claim 15, wherein the collected signal information also provides an indication of a wideband amplitude modulation (WBAM) level associated with the received signal.

17. The receiver of claim 10, wherein the signal quality circuit includes at least one of an average detector, a peak detector and a full-wave detector.

18. The receiver of claim 17, wherein at least one output of the at least one of an average detector, a peak detector and a full-wave detector is utilized to initiate at least one of a soft-mute, a high-cut and a stereo noise control function.

19. An automotive subsystem that includes a mobile receiver that exhibits improved signal processing in the presence of multipath distortion, the mobile receiver being located within a motor vehicle, the mobile receiver comprising:
a tuner module;
a signal quality circuit coupled to the tuner module;
a memory subsystem for storing information;
at least one of a vehicle sensor and a ground positioning system (GPS) receiver for providing an indication of the speed of the vehicle; and
a processor coupled to the memory subsystem, the signal quality circuit and the at least one of a vehicle sensor and a ground positioning system (GPS) receiver, the processor executing code for causing the processor to perform the steps of:
determining a speed of the vehicle;
collecting signal information on a selected signal received by the mobile receiver, wherein the collected signal information is provided by the signal quality circuit and provides an indication of the quality of the received signal; and
modifying at least one time constant associated with processing of the collected signal information responsive to the determined speed.

20. The subsystem of claim 19, wherein the at least one time constant includes an attack time and a decay time of the signal quality circuit, and wherein a length of the at least one time constant is inversely proportional to the speed of the vehicle.

21. The subsystem of claim 19, wherein the collected signal information provides an indication of at least one of an ultrasonic noise (USN) level associated with the received signal and a wideband amplitude modulation (WBAM) level associated with the received signal.

22. The subsystem of claim 19, wherein the signal quality circuit includes at least one of an average detector, a peak detector and a full-wave detector, and wherein at least one output of the at least one of an average detector, a peak detector and a full-wave detector are utilized to initiate at least one of a soft-mute, a high-cut and a stereo noise control function.

23. A mobile receiver that exhibits improved signal processing in the presence of multipath distortion, the mobile receiver being located within a vehicle, the mobile receiver comprising:
a tuner module;
a signal quality circuit coupled to the tuner module; and
a control circuit coupled to the signal quality circuit, the control circuit performing the steps of:
determining a speed of the vehicle;
collecting signal information on a selected signal received by the mobile receiver, wherein the collected signal information is provided by the signal quality circuit and provides an indication of the quality of the received signal; and
modifying at least one time constant associated with processing of the collected signal information responsive to the determined speed.

24. The receiver of claim 23, wherein the control circuit is coupled to a vehicle sensor that provides the speed of the vehicle.

25. The receiver of claim 23, wherein the control circuit is coupled to a ground positioning system (GPS) receiver that provides vehicle locations from which the speed of the vehicle is determined.

26. The receiver of claim 23, wherein the at least one time constant includes an attack time and a decay time of the signal quality circuit.
